(19) United States
(12) Patent Application Publication
(10) Pub. No.: US 2016/0117179 A1
(43) Pub. Date: Apr. 28, 2016

(54) COMMAND REPLACEMENT FOR COMMUNICATION AT A PROCESSOR

(71) Applicant: Advanced Micro Devices, Inc., Sunnyvale, CA (US)

(72) Inventors: Eric Morton, Austin, TX (US); Patrick Conway, Los Altos, CA (US); Greggory Douglas Donley, San Jose, CA (US); Vydhyanathan Kalyanasundharam, San Jose, CA (US)

(21) Appl. No.: 14/523,037

(22) Filed: Oct. 24, 2014

(51) Int. Cl. G06F 9/445; G06F 9/54

(52) U.S. Cl. CPC G06F 9/44505; G06F 9/54

(57) ABSTRACT

A command replacement module at a coherency manager of a processor receives commands to be communicated over the communication fabric. For each received command of a specified type, the command replacement module compares a data payload of the command to a stored set of data patterns and, in response to a match, replaces the command with a replacement command, wherein the replacement command implies the contents of the data payload. The replacement command is communicated to the original commands destination via the communication fabric. In response to receiving the replacement command, the destination reconstructs the original command, deriving the data payload from the replacement command.

### BACKGROUND

1. Field of the Disclosure

The present disclosure relates generally to processors and more particular to communication of commands at a processor.

2. Description of the Related Art

As processors have scaled in performance, they have increasingly employed multiple processing elements, such as multiple processor cores and multiple processing units (e.g., one or more central processing units integrated with one or more graphics processing units). During operation, the processing elements exchange communications, including commands to read or write data from one processing element to another. However, in processors with a large number of processing, elements, the relatively high number of commands can consume an undesirably large portion of the communication fabric bandwidth, thereby increasing the power consumption and reducing the efficiency of the processor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor in accordance with some embodiments.

FIG. 2 is a block diagram of a command replacement module of FIG. 1 in accordance with some embodiments.

FIG. 3 is a diagram illustrating example operations of the command replacement module of FIG. 2 in accordance with some embodiments.

FIG. 4 is a flow diagram illustrating replacement of a command for communication via a switch fabric of the processor of FIG. 1 in accordance with some embodiments.

FIG. 5 is a flow diagram of a method of translating a replaced command to a command with a data payload at the processor of FIG. 1 in accordance with some embodiments.

FIG. 6 is a flow diagram illustrating a method for designing and fabricating an integrated circuit device implementing at least a portion of a component of a processing system in accordance with some embodiments.

### DETAILED DESCRIPTION

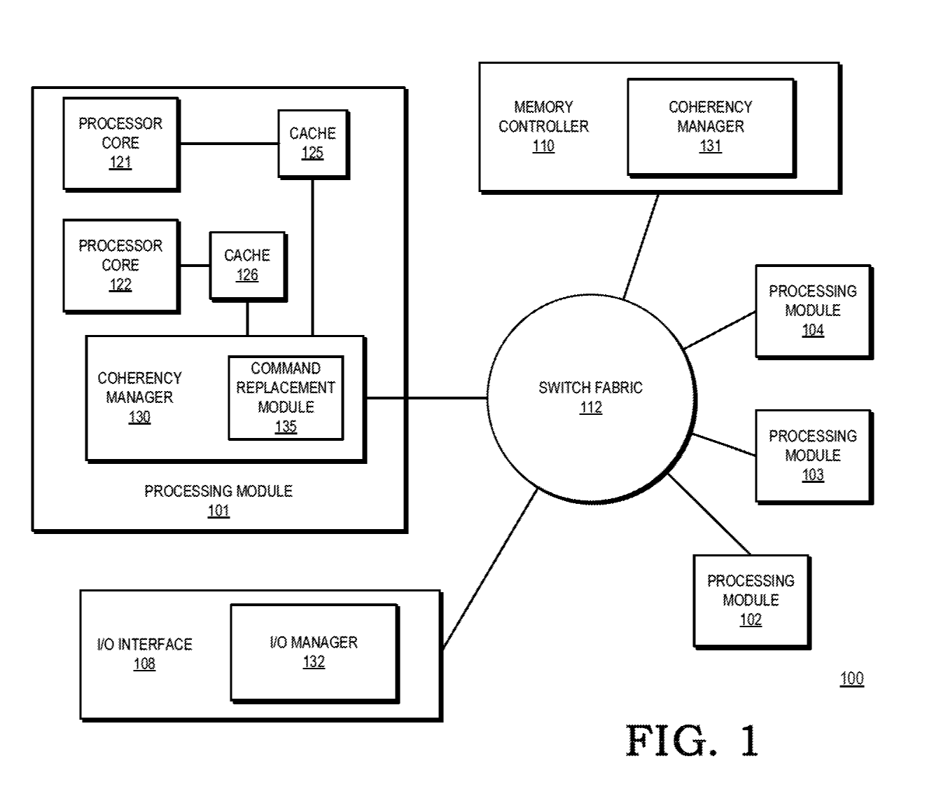

FIGS. 1-6 illustrate techniques for reducing the amount of data communicated over a communication fabric of a processor by replacing selected types of commands to be communicated with replacement commands having a smaller data payload or having no data payload. A command replacement module at a coherency manager of the processor receives commands to be communicated over the communication fabric. For each received command of a specified type, the command replacement module compares a data payload of the command to a stored set of data patterns and, in response to a match, replaces the command with a replacement command, wherein the replacement command implies the contents of the data payload. The replacement command is communicated to the original command's destination via the communication fabric. In response to receiving the replacement command, the destination reconstructs the original command, deriving the data payload from the replacement command. The original command is thus communicated to the destination, but the bandwidth used for the communication is reduced, reducing power consumption and improving efficiency at the processor.

To illustrate via an example, in some scenarios the processing modules of a processor can generate a number of write commands requesting that others of the processing modules write a data payload consisting of the value zero at each bit location (so that the overall value: to be written is a zero value). In a conventional processor, the write commands are communicated between the processors are communicated over the communication fabric, with each zero-value payload consuming fabric bandwidth. Under the techniques disclosed herein, the command replacement module can, in response to detecting the zero-value payload, replace the write command with a specified replacement command, referred to for purposes of discussion as a zero-write command. The zero-write command does not include a data payload (or includes a smaller zero-value payload than the original write command) and is therefore smaller than the original write command. The zero-write command is communicated via the communication fabric to the destination in place of the original write command, thereby reducing the amount of fabric bandwidth consumed. At the destination, the write-zero command is translated back to a write command having a zero-payload of the same size as the original write command, effectively recreating the original write command at the destination. The zero-value payload is thus transferred to the destination while reducing the amount of fabric bandwidth consumed.

FIG. 1 illustrates a block diagram of a processor 100 in accordance with some embodiments. The processor 100 includes processing modules 101-104, an input/output (I/O) interface 108, a memory controller 110, and a switch fabric 112. In some embodiments, the processor 100 is packaged in a multichip module format, wherein the processing modules 101-104, the I/O interface 108, and the memory controller 110 are each formed on different integrated circuit die and then packaged together, with interconnects between the dies forming at least a portion of the switch fabric 112. The processor 100 is generally configured to be incorporated into an electronic device, and to execute sets of instructions (e.g., computer programs, apps, and the like) to perform tasks on behalf of the electronic device. Examples of electronic devices that can incorporate the processor 100 include desktop or laptop computers, servers, tablets, game consoles, compute-enabled mobile phones, and the like.

The memory controller 110 is connected to one or more memory modules (not shown) that collectively form the system memory for the processor 100. The memory modules can include any of a variety of memory types, including random access memory (RAM), flash memory, and the like, or a combination thereof. The memory modules includes multiple memory locations, with each memory location associated with a different memory address. The memory controller 110 is configured to receive read and write commands via the switch fabric 112 and to provide control signaling to the memory modules to execute those commands.

The I/O interface 108 is a module that provides an interface between the processing modules 101-104 and one or more input/output devices, such as a display device, printer device, computer input devices such as a keyboard, touchscreen, mouse, and the like, a network interface device, and the like. In at least one embodiment, the I/O interface 108 provides at least a physical (PHY) layer interface to the one or more input/output devices.

The switch fabric 112 is a communication fabric that routes messages between the processing modules 101-104, and between the processing modules 101-104 and the memory controller 110. Examples of messages communicated over the switching fabric 112 can include status updates and data transfers between the processing modules 101-104, coherency probes and coherency probe responses, and commands. As used herein, a command refers to a communication between processing modules, or between a processing module and another entity (e.g., the memory controller 110), requesting that an action be taken. Examples of commands can include write commands, requesting that data be written to a cache or other memory location, read response commands, returning data from a memory location, victim block commands (e.g., a write command upon a cache eviction that does not trigger coherency probes), and the like. A command includes a command code that indicates the type of command. In addition, some commands include a data payload (sometimes referred to simply as a “payload”) that stores data to be used to execute the command.

The processing module 101 includes processor cores 121 and 122, caches 125 and 126, a coherency manager 130. The processing modules 102-104 include similar elements as the processing module 101. In some embodiments, different processing modules can include different elements, including different numbers of processor cores, different numbers of caches, and the like. Further, in some embodiments the processor cores or other elements of different processing modules can be configured or designed for different purposes. For example, in some embodiments the processing module 101 is designed and configured as a central processing unit to execute general purpose instructions for the processor 100 while the processing module 102 is designed and configured as a graphics processing unit to perform graphics processing for the processor 100. In addition, it will be appreciated that although for purposes of description the processing module 101 is illustrated as including a single dedicated cache for each of the processor cores 121 and 122, in some embodiments the processing modules can include additional caches, including one or more caches shared between processor cores, arranged in a cache hierarchy.

Each of the processing modules 101-104 includes a coherency manager (e.g., coherency manager 130 of processing module 101) to interface with the memory controller 110 and the caches of the other processing modules. In response to memory access requests from their respective processor cores, the coherency managers generate commands targeted to other processing modules. For example, in response to a memory access request from the processor core 122 to write data at a cache of the processing module 103, the coherency manager 130 can generate a write command having a data payload of the data to be written to the cache. In addition, the memory controller 110 includes a coherency manager 131 and the I/O interface 108 includes an I/O manager 132, each to perform similar coherency and other functions.

Each of the coherency managers of the processing modules 101-104, as well as the coherency manager 131 of the memory controller 110 and the manager 132, includes a command replacement module (e.g., command replacement module 135 of coherency manager 130). Each command replacement module is configured to receive commands from its respective connected coherency manager and to determine whether the command is a replaceable command. In some embodiments, the command replacement module identifies a replaceable command in response to a data payload of the received command matching one of a set of stored data patterns. In some embodiments, the command replacement module also identifies replaceable commands based on the type of received command. Thus, for example, in some embodiments only write instructions having data payloads that match one of a set of stored data patterns are identified as replaceable commands.

In response to identifying a replaceable command, the command replacement module replaces the original command with a replacement command. The replacement command has a command code that indicates the data pattern of the payload of the original command. In addition, the replacement command has no payload, or has a payload smaller than that of the original command. The command replacement module provides the replacement command to the switching fabric 112 for transmission to the destination processing module targeted by the original command.

The command replacement modules receive commands from the switching fabric 112 and identify whether a received command is a replacement command. In response to identifying a replacement command, a command replacement module identifies, based on the command code of the replacement command, a type of the original command that was replaced by the replacement command. In addition, the command replacement module identifies the data payload of the original command as indicated by the command code of the replacement command (and by the payload, if any, of the replacement command). Based on the type of the original command and the data payload of the original command, the receiving replacement module recreates the original command and provides it to its connected coherency manager for execution.

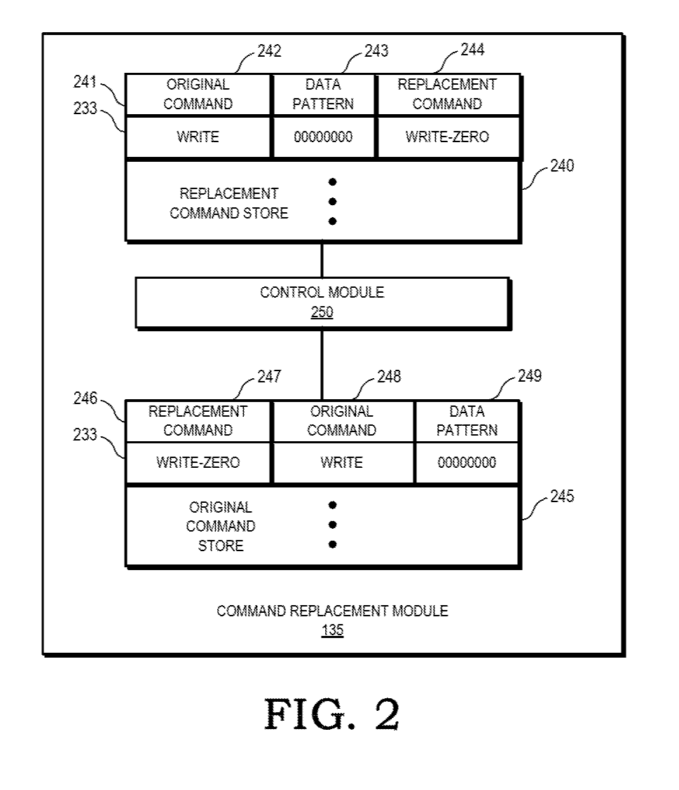

FIG. 2 illustrates a block diagram of the command replacement module 135 of FIG. 1 in accordance with some embodiments. The command replacement module includes a replacement command store 240, an original command store 245, and a control module 250. The control module 250 is one or more circuits generally configured to replace selected commands for communication via the switching fabric 112, and to translate received replacement commands back to their original commands, as described further herein.

The replacement command store 240 includes a number of entries (e.g., entry 241) with each entry including an original command field (e.g., original command field 242), a data pattern field (e.g., data pattern field 243), and a replacement command field (e.g., replacement command field 244). The original command field indicates a command code for a type of command that is eligible for replacement by the command replacement module 135. The data pattern field stores a data pattern for a command payload. The replacement command field indicates a replacement command for an original command having a command code that matches the original command field and a payload that matches the data pattern field. Thus, in the illustrated example, entry 233 indicates that a WRITE command having a data payload of zero at each of 8 bit positions is to be replaced by the command WRITE-ZERO.

In operation, in response to receiving an original command from the coherency manager 130, the control module 250 traverses the entries of the replacement command store, comparing the original command fields of the entries to the command code of the original command. In response to a match, the control module 250 compares the data payload of the original command to the corresponding data pattern field. In response to identifying a match at both the original command field and the data pattern field, the control module 250 replaces the original command with the command in the corresponding replacement command field. The control module 250 communicates the replacement command to the switch fabric 112 in place of the original command, thereby saving fabric bandwidth.

The original command store 245 includes a number of entries (e.g., entry 246) with each entry including a replacement command field (e.g., replacement command field 247), an original command field (e.g., original command field 248), and a data pattern field (e.g., data pattern field 249). The replacement command field indicates a command code for a replacement command. The original command field indicates the command code for the original command corresponding to the replacement command. The data pattern field indicates the payload of the original command corresponding to the replacement command. Thus, entry 233 indicates that the WRITE-ZERO replacement command corresponds to an original command having the WRITE command code and a data payload of zero at each of 8 bit positions.

In operation, in response to receiving a command from the switch fabric 112, the control module 250 compares the command code of the received command to the replacement command fields of the entries of the original command store 245. In response to identifying a match, the control module 250 identifies that the received command is a replacement command. In response, the control module 250 forms a command having the command code of the corresponding original command field and a data payload of the corresponding data payload field. The control module 250 thereby translates the received replacement command back to its corresponding original command. The control module 250 provides the original command to the coherency manager 130 for execution.

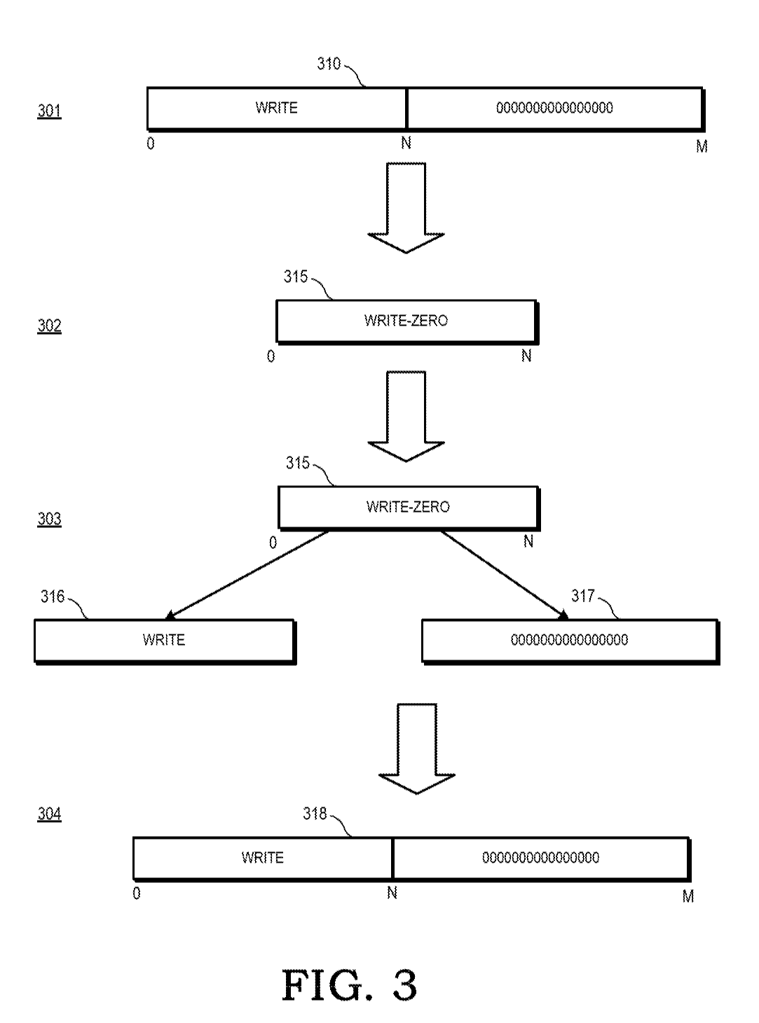

FIG. 3 illustrates an example of command translation at the processor 100 in accordance with some embodiments. In the depicted example, the command replacement module 135 receives, at time 301, an original command 310. The original command has a command code indicating it is a WRITE instruction and a data payload of zero at each of 16 bit positions. In the illustrated example, the total size of the original command, including the command code and data payload, is M bits.

The control module 250 matches the original command 310 to an entry of the replacement command store 240, indicating that the original command 310 is to be replaced by the command WRITE-ZERO. Accordingly, at time 302 the control module 250 generates a replacement command 315 having a command code indicating the WRITE-ZERO command. The WRITE-ZERO command does not have a data payload, as the data to be written is implied by the command code itself. Accordingly, the replacement command 315 is only N bits in size, where N is less than M. The control module 250 communicates the replacement command 315 to the switch fabric 112 in place of the original command 310.

At time 303 the replacement command 315 is received at the destination for the original command 310. The command replacement module at the destination compares the command code of the replacement command 315 to the entries of its original command store, and identifies a replacement command. The command replacement module determines that the received replacement command corresponds to an original command having a command code 316 and a data payload 317. As illustrated, the command code 316 and data payload 317 match the command code and payload of the original command 310. At time 304 the command replacement module generates the command 318 having the command code 316 and the data payload 317. The command replacement module thus generates a command that matches the original command 310. The command replacement module provides the command 318 to its targeted destination for execution.

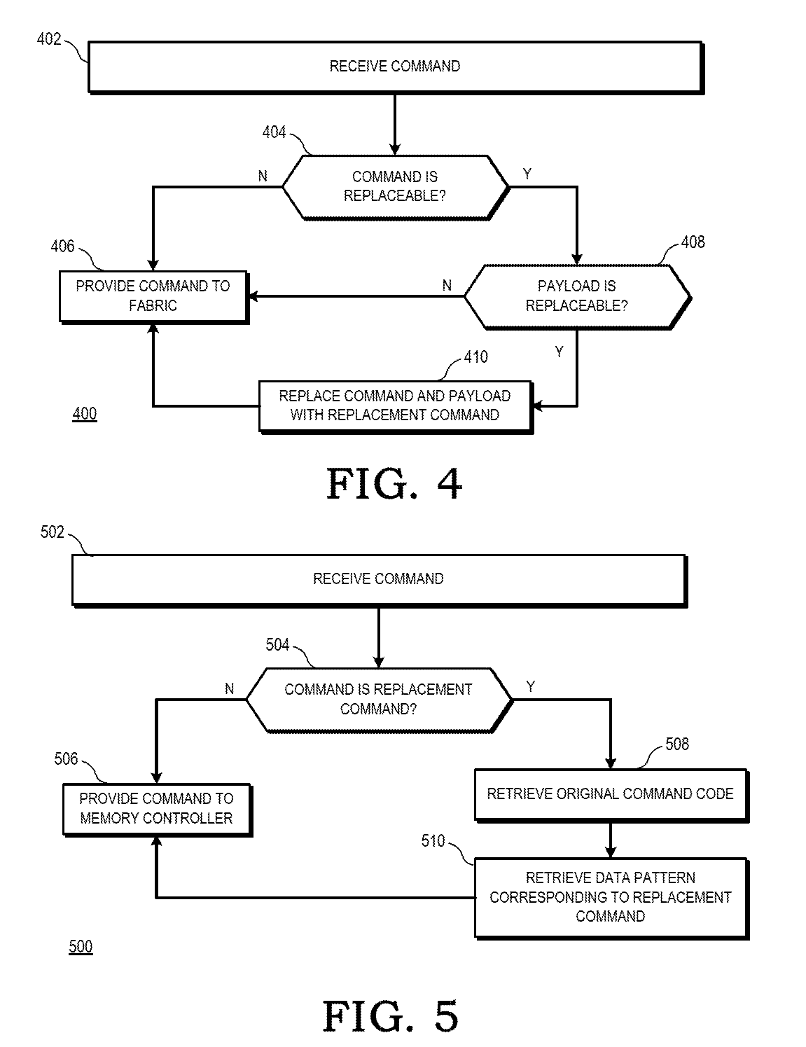

FIG. 4 illustrates a flow diagram of a method 400 of replacing commands at the command replacement module 135 of FIG. 2 in accordance with some embodiments. At block 402 the command replacement module 135 receives a command from the coherency manager 130. At block 404 the command replacement module 135 determines Whether the received command is of a type that is replaceable. In some embodiments, the command replacement module 135 identifies that the command is of a replaceable type by identifying a match between the received command code and one or more entries of the replacement command store 240. If the command replacement module determines that the command is not replaceable, the method flow moves to block 406 and the command replacement module 135 sends the command, as received, to the switch fabric 112 for communication.

Returning to block 404, if the command replacement module 135 identifies the received command as type of command that is replaceable, the method flow moves to block 408 and the command replacement module 135 determines whether the data payload of the received command is replaceable. In some embodiments, the command replacement module identifies that the payload is replaceable by matching the payload to a data pattern field of the one or more entries of the replacement command store 240 that were identified at block 404. If the command replacement module determines that the data payload is not replaceable, the method flow moves to block 406 and the command replacement module 135 sends the command, as received, to the switch fabric 112 for communication.

If, at block 408, the command replacement module 135 determines that the data payload is replaceable, the method flow moves to block 410 and the command replacement module 135 replaces the received command with the replacement command indicated by the command code and data payload. The method flow proceeds to block 406 and the command replacement module 135 sends the replacement command, instead of the original received command, to the switch fabric 112 for communication.

FIG. 5 illustrates a flow diagram of a method 500 of translating replacement commands back to original commands at the command replacement module 135 of FIG. 2 in accordance with some embodiments. At block 502 the command replacement module 135 receives a command from the switch fabric 112. At block 504 the command replacement module 135 determines whether the received command is replacement command. In some embodiments, the command replacement module 135 identifies that the command is a replacement command by identifying a match between the received command code and an entry of the original command store 245. If the command replacement module determines that the command is not a replacement command, the method flow moves to block 506 and the command replacement module 135 sends the command, as received, to the coherency manager 130 for execution.

Returning to block 504, if the command replacement module 135 identifies the received command as a replacement command, the method flow moves to block 508 and the command replacement module 135 identifies the original command code for the original command corresponding to the replacement command. At block 510 the command replacement module 135 identifies the data pattern indicated by the replacement command. The command replacement module 135 forms a command using the command code identified at block 506 and a payload matching the data pattern identified at block 510, thus translating the received replacement command back to its corresponding original command. The method flow moves to block 506 and the command replacement module 135 provides the original command, rather than the replacement command, to the coherency manager 130 for execution.

In some embodiments, the apparatus and techniques described above are implemented in a system comprising one or more integrated circuit (IC) devices (also referred to as integrated circuit packages or microchips), such as the processor described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

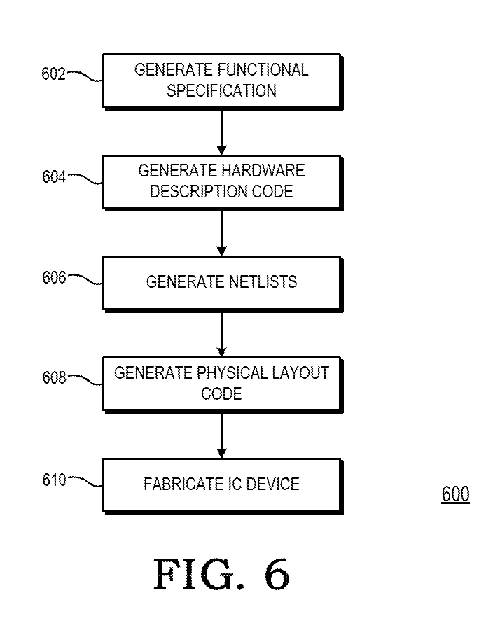

FIG. 6 is a flow diagram illustrating an example method 600 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any of all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving from a first processing module a first command for communication to a second processing module of a processor;
in response to identifying that a data payload of the first command matches a first data pattern, replacing the first command with a first replacement command: and
communicating the first replacement command to the second processing module.

2. The method of claim 1, wherein replacing the first command with the first replacement command comprises:
replacing the first command with the first replacement command in response to determining the first command is of a selected type of command type.

3. The method of claim 2, wherein the selected type of command comprises a write command type.

4. The method of claim 1, wherein the first replacement command does not include a data payload.

5. The method of claim 1, wherein the first replacement command includes a smaller data payload than a data payload of the first command.

6. The method of claim 1, further comprising:
receiving from the first processing module a second command for communication to the second processing module; and
in response to identifying that a data payload of the second command does not matches the first data pattern, communicating the second command to the second processing module.

7. The method of claim 1, further comprising:
receiving from the first processing module a second command for communication to the second processing module of a processor; and
in response to identifying that a data payload of the second command matches a second data pattern, replacing the second command with a second replacement command; and
communicating the second replacement command to the second processing module.

8. The method of claim 1, wherein replacing the first command comprises replacing the first command with the first replacement command at a coherency manager of the processor.

9. The method of claim 1, further comprising:
in response to receiving the first replacement command at the second processing module, replacing the first replacement command with the first command; and
executing the first command at the second processing module.

10. A method, comprising
receiving, at a first processing module of a processor, a first command from a second processing module of the processor;
in response to determining the first command is a replacement command for a second command:
replacing the first command with the second command; and
executing the second command at the first processing module.

11. The method of claim 10, wherein replacing the first command with the second command comprises:
replacing a command code of the first command with a command code of the second command; and
adding a data payload to the command code of the second command.

12. The method of claim 11, further comprising:
identifying the data payload based on the command code of the first command.

13. A processor, comprising:
a first processing module to generate a first command for communication to a second processing module the processor;
a command replacement module to replace the first command with a first replacement command in response to identifying that a data payload of the first command matches a first data pattern; and
a switch fabric to communicate the first replacement command to the second processing module.

14. The processor of claim 13, wherein the command replacement module is to replace the first command with the first replacement command in response to determining the first command is of a selected type of command.

15. The processor of claim 14, wherein the selected type of command comprises a write command type.

16. The processor of claim 13, wherein the first replacement command does not include a data payload.

17. The processor of claim 13, wherein the first replacement command includes a smaller data payload than a data payload of the first command.

18. The processor of claim 13, wherein the command replacement module is to:
in response to identifying that a data payload of a second command does not match the first data pattern, communicate the second command to the switch fabric.

19. The processor of claim 13, wherein the command replacement module is to:
receive from the first processing module a second command for communication to the second processing module; and
in response to identifying that a data payload of the second command matches a second data pattern, replace the second command with a second replacement command; and
communicate the second replacement command to the switch fabric for communication to the second processing module.

20. The processor of claim 13, wherein the second processing module is to:
replace the first replacement command with the first command; and
execute the first command.
